(19) United States
(12) Patent Application Publication
(10) Pub. No.: US 2010/0020342 A1
(43) Pub. Date: Jan. 28, 2010

(54) IMAGE FORMING APPARATUS, PRINT INSTRUCTION APPARATUS AND RECORDING MEDIUM

(75) Inventor: Kuniyasu SHIBATA, Hachioji-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 12/504,707

(22) Filed: Jul. 17, 2009

(30) Foreign Application Priority Data
Jul. 22, 2008 (JP) 2008-188396

(51) Int. Cl. G06F 15/00

(52) U.S. Cl. 358/1.9; 358/1.15

(57) ABSTRACT

Disclosed an image forming apparatus to perform image forming processing based on a print job, which image forming apparatus including: a storage section to store obverse side information indicating an attribute specific to an obverse side of a sheet and reverse side information indicating an attribute specific to a reverse side of the sheet; and a control section to perform image forming processing on the obverse side of the sheet in an image forming condition according to the obverse side information stored in the storage section, and to perform image forming processing on the reverse side of the sheet in an image forming condition according to the reverse side information stored in the storage section, when image forming processing is performed on both sides of the sheet based on the print job.

### CROSS-REFERENCE TO RELATED APPLICATION

The present U.S. patent application claims a priority under the Paris Convention of Japanese patent application No. 2008-188396 filed on Jul. 22, 2008, which shall be a basis of correction of an incorrect translation.

### BACKGROUND

1. Field of the Invention

The present invention relates to an image forming apparatus, a print instruction apparatus and a recording medium.

2. Description of Related Art

An image forming apparatus such as Multifunction Peripheral (MFP) previously receives an input of sheet information (such as paper quality, color, basis weight of a sheet) of a print sheet to be image-formed so as to switch a control of image forming processing based on the sheet information, and thereby a jam is reduced and image quality is improved.

In recently years, there has been widely used an image forming apparatus which automatically detects the sheet information of the print sheet to switch the control of image forming processing based on the detected sheet information. For example, there has been known an image forming apparatus of an electrophotography system which changes a fixing temperature between cases of plain sheet and thick sheet (Japanese Patent Application Laid-Open Publication No. Hei 5-27642).

By the way, when duplex printing is performed on a print sheet (for example, a print sheet where types of sheet processing of the obverse side and reverse side are different from each other) whose obverse side and reverse side have different attributes from each other, an image forming apparatus can accept only one-side sheet information. Thus, when each of the obverse side and reverse side needs to be image-formed in most appropriate conditions, a user would have to perform the following operations.

Specifically, the user firstly inputs the sheet information of the obverse side into the image forming apparatus. Secondly, the user allows the image forming apparatus to perform single-side printing on the obverse side of the print sheet. Next, the user inputs the sheet information of the reverse side into the image forming apparatus. Then, the user allows the image forming apparatus to perform single-side printing on the reverse side of the print sheet.

However, when the image forming processing is performed on both sides of the sheet whose obverse side and reverse side have different attributes from each other (i.e., when duplex printing is performed), the user needs to reset the print sheet on which single-side printing has been performed in a feeding section again, and to input the sheet information again. As result, user's working efficiency is lowered.

### SUMMARY

The prevent invention has been achieved in view of the abovementioned problems, and the object of the present invention is to improve user's working efficiency when image forming processing is performed on both sides of a sheet whose obverse side and reverse side have different attributes from each other.

To achieve at least one of the abovementioned objects, according to one aspect of the present invention, there is provided an image forming apparatus to perform image forming processing based on a print job, which image forming apparatus including: a storage section to store obverse side information indicating an attribute specific to an obverse side of a sheet and reverse side information indicating an attribute specific to a reverse side of the sheet; and a control section to perform image forming processing on the obverse side of the sheet in an image forming condition according to the obverse side information stored in the storage section, and to perform image forming processing on the reverse side of the sheet in an image forming condition according to the reverse side information stored in the storage section, when image forming processing is performed on both sides of the sheet based on the print job.

Preferably, the storage section further stores common information indicating an attribute of the sheet itself, which attribute is common between the obverse side and the reverse side of the sheet, and the control section performs image forming processing on the obverse side of the sheet in an image forming condition according to the obverse side information and the common information which are stored in the storage section, and performs image forming processing on the reverse side of the sheet in an image forming condition according to the reverse side information and the common information which are stored in the storage section.

Preferably, the image forming apparatus further includes: an operation section to receive the obverse side information, the reverse side information and the common information respectively, and wherein the control section allows the storage section to store the obverse information, the reverse information and the common information which are received by the operation section.

Preferably, each item regarding the obverse side information and the reverse side information which are received by the operation section includes at least one of items regarding a type of sheet processing and a sheet color, and an item regarding the common information received by the operation section includes at least one of items regarding a basis weight of the sheet and presence/absence of a punch hole.

Preferably, the image forming apparatus includes: a feeding section to feed the stored sheet, and wherein when image forming processing is performed on both sides of the sheet according to the print job, the control section specifies the sheet specified in the print job based on the obverse side information, the reverse side information, and the common information which are stored in the storage section, to supply the specified sheet to the feeding section.

Moreover, according to one aspect of the present invention, there is provided a print instruction apparatus to transmit a print job to an image forming apparatus to allow the image forming apparatus to perform image formation, which print instruction apparatus including: a storage section to at least temporarily store obverse side information indicating an attribute specific to an obverse side of a sheet and reverse side information indicating an attribute specific to a reverse side of the sheet; and a control section to generate the print job including the obverse side information and the reverse side information to transmit the generated print job to the image forming apparatus when a user instructs to perform image formation on both sides of the sheet.

Preferably, the storage section further stores common information indicating an attribute of the sheet itself, which is common between the obverse side and the reverse side of the sheet, and the control section generates, as the print job, a print job further including the common information.

### BRIEF DESCRIPTION OF THE DRAWINGS

The present invention will become more fully understood from the detailed description given hereinbelow and the appended drawings, and thus are not intended as a definition of the limits of the present invention, and wherein;

FIG. 1 is a system configuration diagram of an image forming system;

FIG. 2 is an apparatus configuration diagram of an image forming apparatus;

FIG. 3 is a block diagram of the image forming apparatus;

FIG. 4 is a data configuration diagram of print job information;

FIG. 5 is a data configuration diagram of feeding section information;

FIG. 6 is a data configuration diagram of print control condition information;

FIG. 7 is an example of a feeding section information setting screen in the image forming apparatus;

FIG. 8 is an example of a feeding section information setting screen in the image forming apparatus;

FIG. 9 is an example of a print job information inputting screen in the image forming apparatus;

FIG. 10 is a block diagram of a client terminal;

FIG. 11 is an example of a printer driver screen;

FIG. 12 is an example of a printer driver screen;

FIG. 13 is an example of a printer driver screen; and

FIG. 14 is a flowchart showing processing to be executed in the image forming apparatus.

### DETAILED DESCRIPTION OF THE PREFERRED EMBODIMENT

Hereinafter, one embodiment of an image forming apparatus according to the present invention will be described with reference to the drawings.

### [System Configuration of Image Forming System]

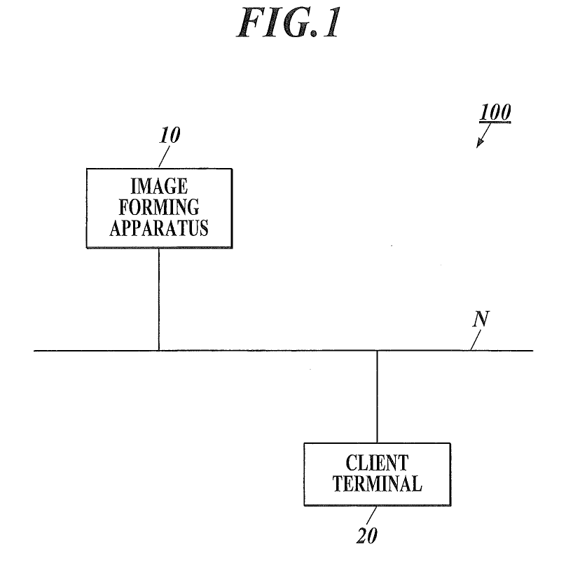

FIG. 1 shows a system configuration of an image forming system 100. As shown in FIG. 1, the image forming system 100 is composed of an image forming apparatus 10 and a client terminal 20 which are data communicatably connected to each other through a communication network N such as a LAN.

The image forming apparatus 10 is so-called Multifunction Peripheral (MFP) including a copying function, image reading function and printing function, and forms an image on a sheet based on a print job (print instruction) transmitted from the client terminal 20, image data read by an image reading section such as a scanner provided in the image forming apparatus 10, and so on.

The client terminal 20 is so-called personal computer, includes a function to transmit the print job to the image forming apparatus 10, and acts as a print instruction apparatus. The client terminal 20 is provided with a printer driver program (hereinafter referred to as simply printer driver in some cases) installed therein, and uses a function of the printer driver to create the print job including print condition data (print job information) to be applied in image formation, image data, and so on, to transmit the created print job to the image forming apparatus 10.

### [Functional Configuration of Image Forming Apparatus]

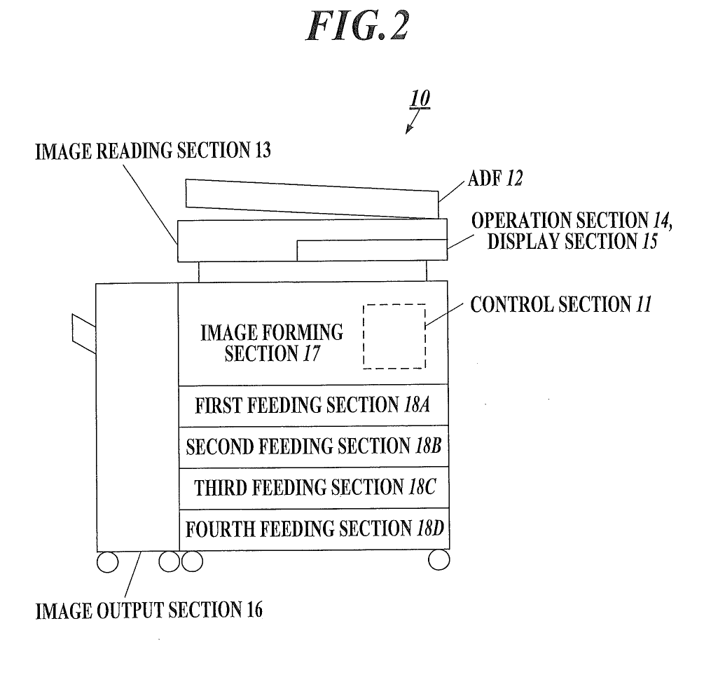

FIG. 2 shows a configuration of the image forming apparatus 10. As shown in FIG. 2, the image forming apparatus 10 is configured to include: a control section 11; an Auto Document Feeder (ADF) 12; an image reading section 13; an operation section 14; a display section 15; an image outputting section 16; an image forming section 17; a first feeding section 18a; a second feeding section 18b; a third feeding section 18c; and a fourth feeding section 18d.

The ADF 12 is an automatic document feeding apparatus, and automatically conveys a single sheet or a plurality of sheets to the image reading section 13.

The image reading section 13 is a function section to optically read the image on the document placed on a document rest to create the image data. Specifically, the image reading section 13 optically scans the document conveyed by the ADF 12 through a contact glass, or optically scans the document placed on the platen glass, to read the image recorded on the document image by photoelectric conversion with a Charge-Coupled Device (CCD) image sensor to create the image data of the read image to output the created image data to the image forming section 17.

The image forming section 17 is a function section to form an image, and includes not-shown photoreceptor, transfer belt, fixer, various conveying belts and the like. The image forming section 17 forms the image on the print sheet based on the image data read by the image reading section 13 or the print job transmitted through the communication I/F section to output the image to the image outputting section 16. As an image forming method, a known image process such as an electrophotography system and electrostatic recording system may be used. Moreover, the image forming section 17 is capable of forming the image on both sides, namely the obverse side and reverse side, of the print sheet.

The control section 11 controls each of the function sections, and includes a Central Processing Unit (CPU), Random Access Memory (RAM), storage section and the like. The details will be described later.

The first feeding section 18a, the second feeding section 18b, the third feeding section 18c and the fourth feeding section 18d store the sheet (print sheet) and send forth the stored print to the image forming section 17 respectively. Hereinafter the first-fourth feeding sections 18a-18d are referred to generically as a feeding section 18.

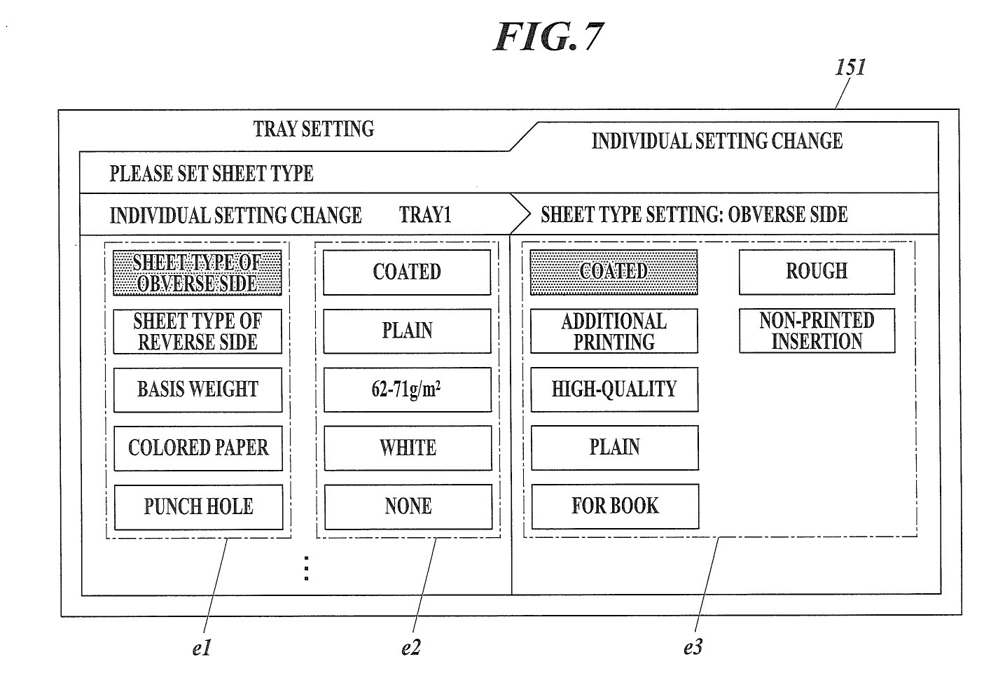

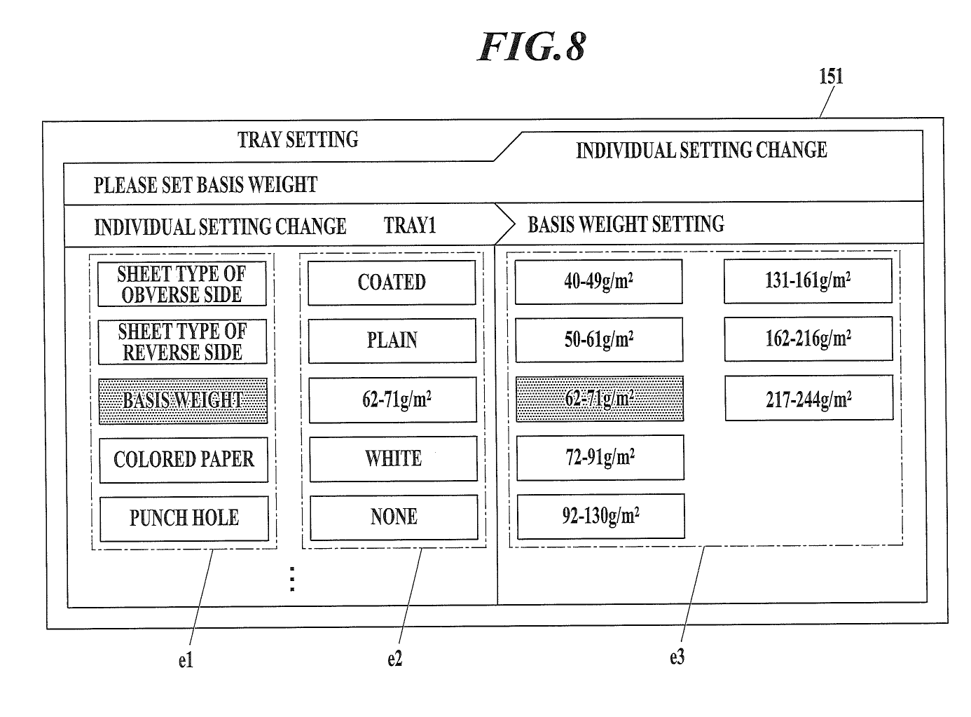

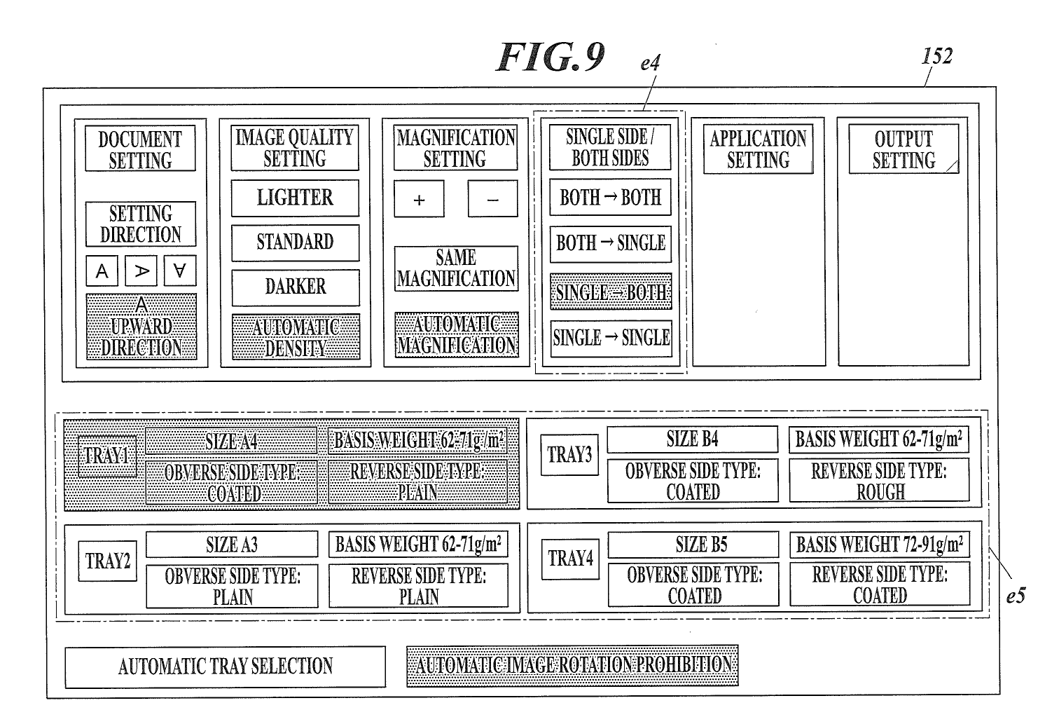

The operation section 14 and the display section 15 are integrally configured with operation input keys, touch panel and the like. The operation section 14 outputs operation signals including a depression signal corresponding to a depressed key, and a position signal corresponding to a pushed position on the touch panel, to the control section 11. Moreover, the display section 15 displays a feeding section information setting screen (see FIGS. 7 and 8), a print job information inputting screen (see FIG. 9), and so on.

A user performs a setting operation of the feeding section information, setting operation of the print job information, starting operation of printing and the like to be hereinafter described, with the touch panel contributing the operation section 14 and the display section 15.

The image outputting section 16 is a function section to perform finishing processing such as punching, stapling, and bookbinding on the sheet conveyed from the image forming section 17 according to the instruction from the control section 11 to output the processed sheet.

### [Functional Configuration and Data Configuration of Control Section]

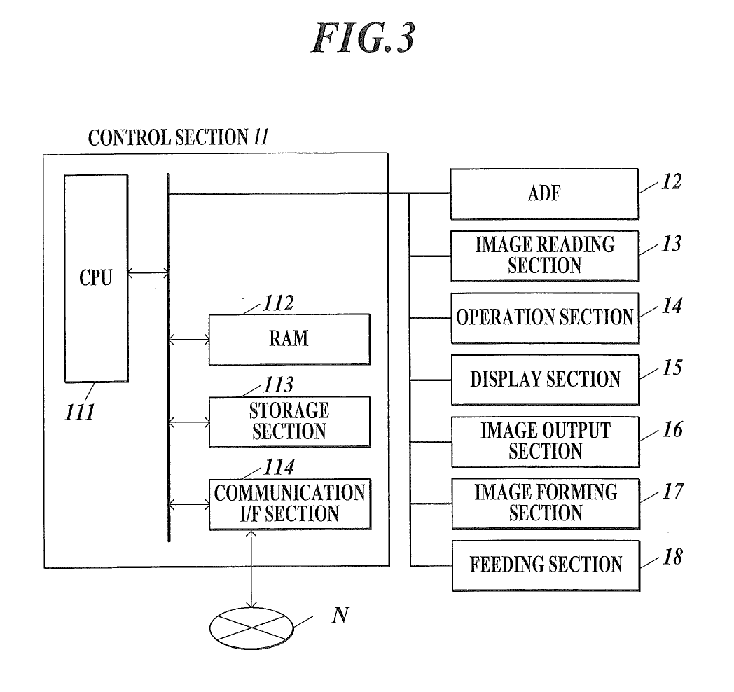

FIG. 3 is a block diagram of the control section 11 and each of the function sections. The control section 11 is configured to include a CPU 111, RAM 112, storage section 113 and communication I/F section 114 which are communicably connected to one another through a bus. In addition, each of the function sections constructing the control section 11 is communicably connected to the ADF 12, image reading section 13, operation section 14, display section 15, image outputting section 16, image forming section 17 and feeding section 18 through the bus. The communication I/F section 114 is communicably connected to the communication network N such as a LAN.

The CPU 111 reads various processing programs stored in the storage section 113 to expand the programs in a work area formed in the RAM 112 to perform various processing in cooperation with the programs. For example, the CPU 111 integrally manages/controls the image forming apparatus 10 by controlling an operation of each of the function sections, controlling data input/output among the function sections, and so on. The function sections are specifically the ADF12, image reading section 13, operation section 14, display section 15, image outputting section 16, image forming section 17 and feeding section 18. The CPU 111 analyzes the print job when receiving the print job to output instructions for image forming processing to each of the function sections.

The RAM 112 is a section to temporarily store various pieces of data read by the image reading section 13 or input from the communication I/F section 114. The stored data is processed by the CPU 111, and transferred to the storage section 113 or the image forming section 17 as necessary.

The RAM 112 stores the print job. The print job is, for example, composed of print job information indicating a print condition and image data indicating the image to be printed. The image data is composed of four colors of cyan (C), yellow (Y), magenta (M) and black (B), for example. The CPU 111 receives the print job from other communication equipments through the communication I/F section 114. Incidentally, the image data may be information read by the image reading section 13, and the print job information may be information set by an input signal from the operation section 14. When the communication I/F section 114 receives the print job, the CPU 111 allows the RAM 112 to store the print job. Incidentally, the print job may include, in place of the image data, the image to be printed in a file format such as Portable Document Format (PDF) and XML Paper Specification (XPS), or in Page Description Language (PDL) format such as PostScript (registered trademark) (PS) and Printer Control Language (PCL).

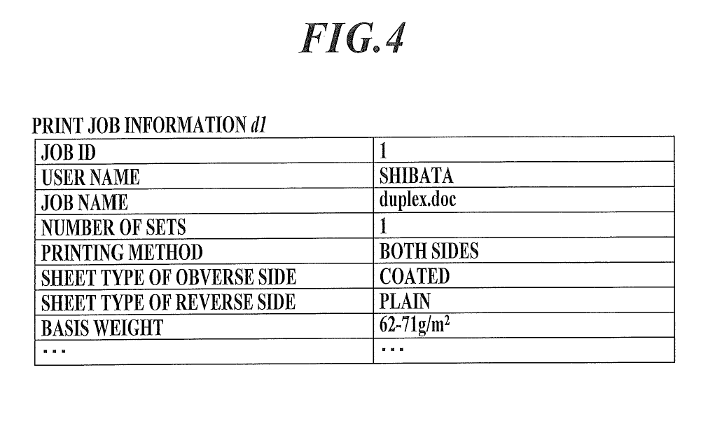

FIG. 4 shows a data configuration of the print job information. The print job information d1 includes information such as “job ID”, “user name”, “job name”, “the number of sets”, “printing method”, “sheet type (obverse side)”, “sheet type (reverse side)”, and “basis weight”. The “printing method” is information indicating which of duplex printing or single-side printing is to be performed, and has a value of one of “both sides” and “single side”. The “both sides” corresponds to duplex printing, and the “single side” corresponds to single-side printing.

The “sheet type (obverse side)” is information of a type of sheet processing on the obverse side of the print sheet, and the “sheet type (reverse side)” is information of a type of sheet processing on the reverse side of the print sheet. Each of pieces of the information includes values such as “plain”, “coated” and “rough”. The “plain” corresponds to a plain sheet, the “coated” corresponds to a coated sheet, and the “rough” corresponds to a rough sheet. When the value of “printing method” is “single side”, the value of “sheet type (reverse side)” becomes invalid.

The basis weight is print sheet weight per one square meter. While the “sheet type (obverse side)” is an attribute specific to the obverse side and the “sheet type (reverse side)” is an attribute specific to the reverse side, the “basis weight” is an attribute of the sheet itself. The attribute of sheet itself is common attribute between the obverse side and the reverse side.

Reverting to FIG. 3, the storage section 113 is composed of a Hard Disk Drive (HDD), a semiconductor nonvolatile memory, and so on. The storage section 113 stores a program for allowing the CPU 111 to control each of the function sections and information regarding processing function of the image forming apparatus 10. These program and information are read as necessary by the CPU 111 to be executed/processed on the RAM 112.

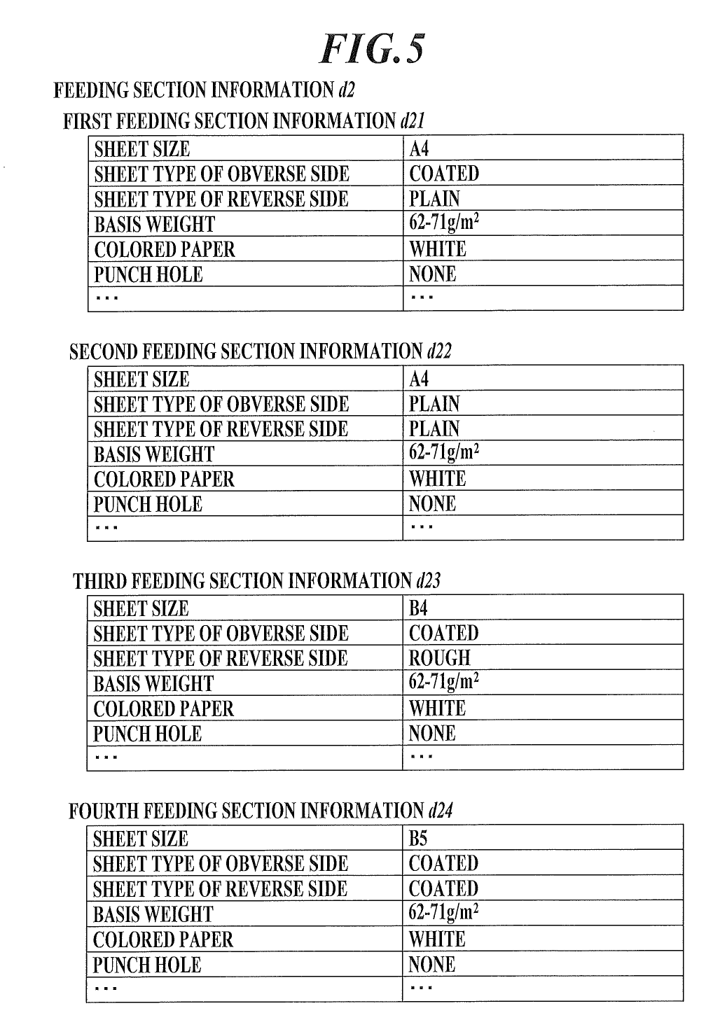

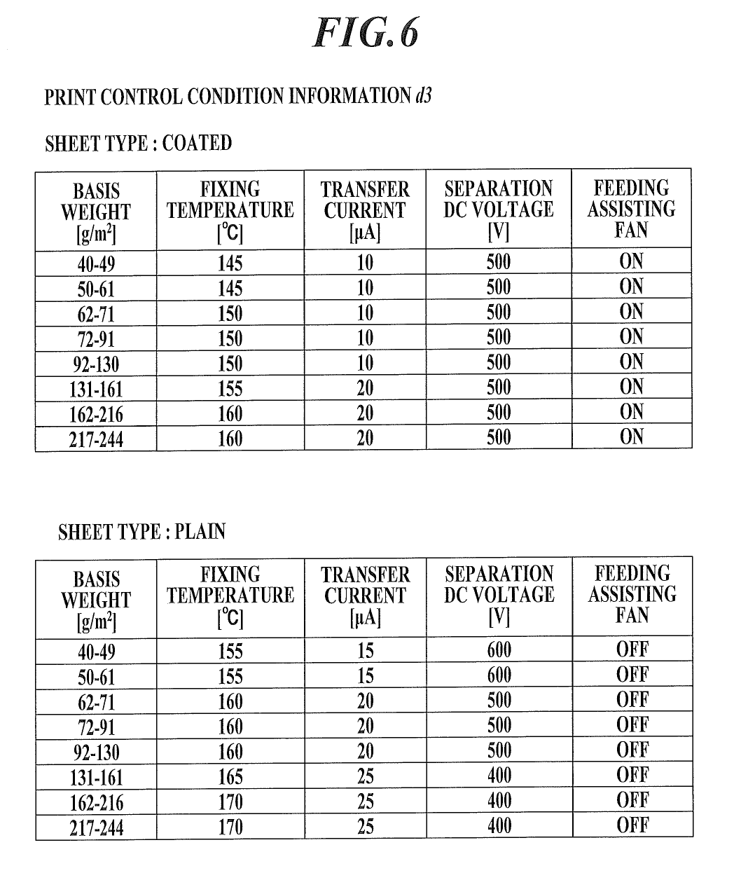

For example, the storage section 113 stores feeding section information d2 (see FIG. 5), print control condition information d3 (see FIG. 6), and the like. The feeding section information d2 is sheet information indicating the attribute of the print sheet stored in the feeding section 18. The print control condition information d3 is information indicating a processing parameter (image forming condition) of print control (image forming processing) according to the attribute (sheet type and the like) of the print sheet. These feeding section information d2 and print control condition information d3 are read by the CPU 11 into the RAM 112 when the image forming apparatus 10 is powered up to start.

FIG. 5 shows a data configuration of the feeding section information d2. The feeding section information d2 includes: a first feeding section information d21 which is sheet information of the print sheet stored in the first feeding section 18a; a second feeding section information d22 which is sheet information of the print sheet stored in the second feeding section 18b; a third feeding section information d23 which is sheet information of the print sheet stored in the third feeding section 18c; and a fourth feeding section information d24 which is sheet information of the print sheet stored in the fourth feeding section 18d. Each of pieces of the first-fourth feeding section information d21-d24 includes sheet information such as “sheet size”, “sheet type (obverse side)”, “sheet type (reverse side)”, “basis weight”, “colored sheet”, “punch hole”, and so on.

The sheet information includes: obverse side information indicating the attribute specific to the obverse side of the sheet; reverse side information indicating the attribute specific to the reverse side of the sheet; and common information indicating the attribute of the sheet itself. As an example of the obverse side information, “sheet type (obverse side)” may be cited, as an example of the reverse side information, “sheet type (reverse side)” may be cited, and as examples of the common information, “sheet size”, ““basis weight”, “colored sheet”, “punch hole” and the like may be cited.

FIG. 6 shows a part of the data configuration of the print control condition information d3. The print control condition information d3 shown in FIG. 6 represents information such as “fixing temperature”, “transfer current”, “separation DC voltage” and “feeding assisting fan” per “basis weight” of the common information, depending on “sheet type (obverse side)” which is one of the pieces of the obverse side information, and “sheet type (reverse side)” which is one of the pieces of the reverse side information. The CPU 111 transmits the instruction regarding the print control to each of the function sections based on these values. Specifically, the CPU 111 sends the instruction regarding the print control to the image forming section 17 based on the corresponding values of “fixing temperature”, “transfer current”, and “separation DC voltage”. The CPU 111 further transmits the instruction regarding the print control to the feeding section 18 based on the corresponding value of “feeding assisting fan”.

For example, when “sheet type (obverse side)” or “sheet type (reverse side)” and “basis weight” which are included in the print job information d1 are “coated” and “72-91g/m²” respectively, the CPU 111 transmits the instruction to form the image in the condition that the fixing temperature is 150° C., the transfer current is 10 μA, and the separation DC voltage is 500V to the image forming section 17, and transmits the instruction to feed the print sheet while the feeding assisting fan is in on-state to the feeding section 18.

On the other hand, when “sheet type (obverse side)” or “sheet type (reverse side)” and “basis weight” which are included in the print job information d1 are “plain” and “131-161 g/m²” respectively, the CPU 111 transmits the instruction to form the image in the condition that the fixing temperature is 165° C., the transfer current is 25 μA, and the separation DC voltage is 400V to the image forming section 17, and transmits the instruction to feed the print sheet while the feeding assisting fan is in off-state to the feeding section 18.

Then, each of the function sections executes processing regarding the print control according to the instruction transmitted from the CPU 111.

Reverting to FIG. 3, the communication I/F section 114 is composed of a LAN interface, modem, and so on, and is a function section to perform data communication with external equipment such as a server, client, other apparatuses, and the like through the communication network N and the like. The communication I/F section 114 receives feeding section information setting data, feeding section information acquisition request, print job and the like from the other communication equipment.

The CPU 111 updates the value of the feeding section information d2 based on the feeding section information setting data when receiving the feeding section information setting data through the communication I/F section 114. Specifically, the CPU 111 updates items such as “sheet type (obverse side)”, “sheet type (reverse side)”, “basis weight”, “colored sheet” and “punch hole” of the first feeding section information d21 stored in the RAM 112 and the storage section 113 based on the feeding section information setting data when receiving the feeding section information setting data regarding the first feeding section 18a.

The CPU 111 allows the RAM 112 to temporality store the print job when receiving the print job through the communication I/F section 114. Then, the CPU 111 performs on the RAM 112 converting processing to convert the image data included in the print job into print image data, which is capable of being image-formed on the print sheet in the image forming section 17. The storage section 113 stores various programs for converting the image data into the print image data, and the CPU 111 reads necessary programs.

The CPU 111 updates the value of the feeding section information d2 based on an input signal from the operation section 14. Specifically, the CPU 111 updates the items such as “sheet type (obverse side)”, “sheet type (reverse side)”, “basis weight”, “colored sheet” and “punch hole” of the first feeding section information d21 stored in the RAM 112 and the storage section 113 based on the input signal when receiving an input signal indicating updating of the feed section information d2 regarding the first feeding section 18a.

The CPU 111 receives the image data from the image reading section 13 to create (set) the print job information based on the input signal from the operation section 14, and then allows the RAM 112 to temporarily store the image data and the print job information as the print job. After that, the CPU 111 executes on the RAM 112 converting processing to convert the image data included in the print job into the print image data, which is capable of being image-formed on the print sheet in the image forming section 17.

The CPU 111 allows the display section 15 to display feeding section information setting screen 151 (see FIGS. 7 and 8) and print job information inputting screen 152 (see FIG. 9) based on the input signal from the operation section 14.

The CPU 111 transmits the feeding section information d2 stored in the RAM 112 to a source of the feeding section information acquisition request when receiving the feeding section information acquisition request through the communication I/F section 114.

### [Feeding Section Information Setting Screen]

Next, FIGS. 7 and 8 show examples of the feeding section information setting screen 151 to be displayed on the display section 15. FIGS. 7 and 8 show same screens.

As shown in FIGS. 7 and 8, the feeding section information setting screen 151 contains a setting item display region e1, setting value display region e2, candidate value display region e3 and the like.

In the setting item display region e1, a list of sheet information (obverse side information, reverse side information, and common information) included in the feeding section information d2 to be set on the feeding section information setting screen 151 is displayed. Specifically, in the setting item display region e1, the setting items such as “sheet type (obverse side)”, “sheet type (reverse side)”, “basis weight”, “colored sheet” and “punch hole” among the sheet information included in the feeding section information d2 are displayed. Any one of these setting items is selected based on user's operation. For example, “sheet type (obverse side)” of the obverse side information is selected in FIG. 7, and “basis weight” of the common information is selected in FIG. 8.

In the setting value display region e2, the value set with respect to the sheet information displayed in the setting item display region e1. For example, in FIGS. 7 and 8, “coated” is set with respect to “sheet type (obverse side)”, “plain” is set with respect to “sheet type (reverse type)”, “62-71 g/m²” is set with respect to “basis weight”, “white” is set with respect to “colored sheet”, and “none” is set with respect to the “punch hole”.

In the candidate value display region e3, candidate values settable with respect to the sheet information selected in the setting item display region e1 are displayed. For example, in FIG. 7, “coated”, “additional printing”, “high-quality”, “plain”, “for book”, “rough”, and “non-printed insertion” are displayed as candidate values settable with respect to “sheet type (obverse side)” selected in the setting item display region e1. In FIG. 8, “40-49 g/m²”, “50-61 g/m²”, “62-71 g/m²”, “72-91 g/m²”, “91-130 g/m²”, “131-161 g/m²”, “162-216 g/m²” and “217-244 g/m²” are displayed as candidate values settable with respect to “basis weight” selected in the setting item display region e1. Any one of these candidate values is selected based on user's operation. For example, “coated” is selected in FIG. 7, and “62-71 g/m²” is selected in FIG. 8. When any one of candidate values is selected, the CPU 111 sets the selected value as the value of the sheet information selected in the setting item display region e1. Then, the CPU 111 reflects the set value of the sheet information in the setting value display region e2.

As described above, among the sheet information displayed in the setting item display region e1, “sheet type (obverse side)” is the obverse side information indicating the attribute specific to the obverse side of the print sheet, and “sheet type (reverse side)” is the reverse side information indicating the attribute specific to the reverse side of the print sheet. In addition, “basis weight”, “colored sheet” and “punch hole” are common information indicating the attribute of the print sheet itself.

Thus, a user can specify each of the attributes of the obverse side and reverse side with respect to the print sheet on the feeding section information setting screen 151. Thus, the obverse side and the reverse side of the same print sheet can be registered individually. On the other hand, a user does not need to input settings of the obverse side and the reverse side separately with respect to the attribute of the print sheet itself, namely items “basis weight”, “colored sheet” and “punch hole” regarding common attribute between the obverse side and the reverse side. In other words, a user needs to input setting separately only with respect to the item “sheet information (“sheet information (obverse side)” and “sheet information (reverse side)”)” regarding the attributes specific to the obverse side and the reverse side. As a result, user's working efficiency is improved when image forming processing is performed on both sides of the print sheet whose obverse side and reverse side have different attributes from each other in most appropriate conditions.

### [Print Job Information Inputting Screen]

Next, FIG. 9 shows an example of the print job information inputting screen 152 to be displayed on the display section 15.

As shown in FIG. 9, the print job information inputting screen 152 includes both sides/single side setting region e4, feeding section information display region e5, and so on.

The both sides/single side setting region e4 is a region for setting the value of “printing method” of the print job information d1.

In the feeding section information display region e5, the values of the feeding section information d2 stored in the RAM 112 and the storage section 113 are displayed. The CPU 111 displays the information in the feeding section information display region e5 based on the feeding section information d2 stored in the RAM 112 when receiving the input signal for displaying the print job information input screen 152 from the operation section 14.

### [Functional Configuration of Client Terminal]

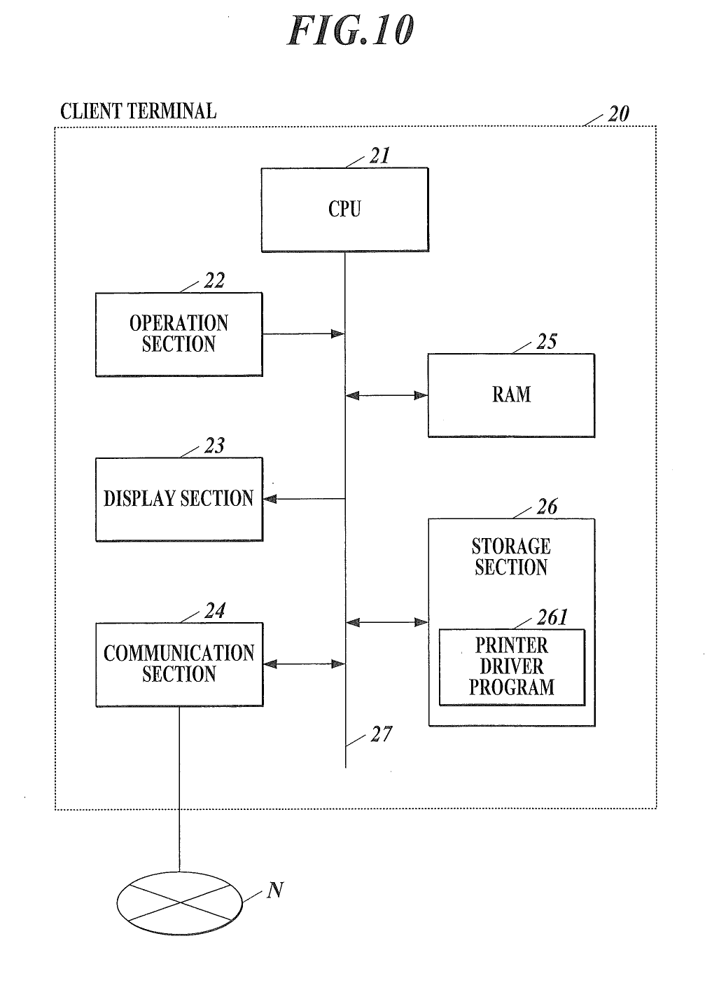

FIG. 10 shows a configuration of the client terminal 20. As shown in FIG. 10, the client terminal 20 includes the CPU 21, the operation section 22, the display section 23, the communication section 24, the Random Access Memory (RAM) 25, and the storage section 26 which are connected to one another through the bus 27.

The CPU 21 reads the various processing programs stored in the storage section 26 to expand the read programs in the work area formed in the RAM 25 to perform various processing in cooperation with the programs, according to the operation signal input from the operation section 22 or the instruction signal received by the communication section 24.

The operation section 22 is equipped with a key board including cursor keys, numeric keys and various function keys, and a pointing device such as a mouse. The operation section 22 outputs the instruction signal input by key operation on the key board or mouse operation to the CPU 21.

The display section 23 is composed of a Liquid Crystal Display (LCD), and displays the input instruction from the operation section 22, data, and the like, according to the instruction of the display signal input from the CPU 21.

The communication section 24 includes a LAN adaptor, router, TA, and the like, and transmits/receives the data to/from the external equipment such as the image forming apparatus 10 connected thereto through the communication network N.

The RAM 25 forms the work area for temporarily storing the various processing programs to be executed by the CPU 21 and the data regarding these programs.

The storage section 26 is a storage device composed of an HDD, semiconductor nonvolatile memory and the like, and stores the various programs, setting data, image data, and so on. The storage section 26 stores also a printer driver program 261.

The CPU 21 reads the printer driver program 261 from the storage section 26 to expand the program in the RAM 25, and generates the print job to be transmitted to the image forming apparatus 10 in cooperation with the program. Then, the CPU 21 transmits the print job to the image forming apparatus 10 through the communication section 24.

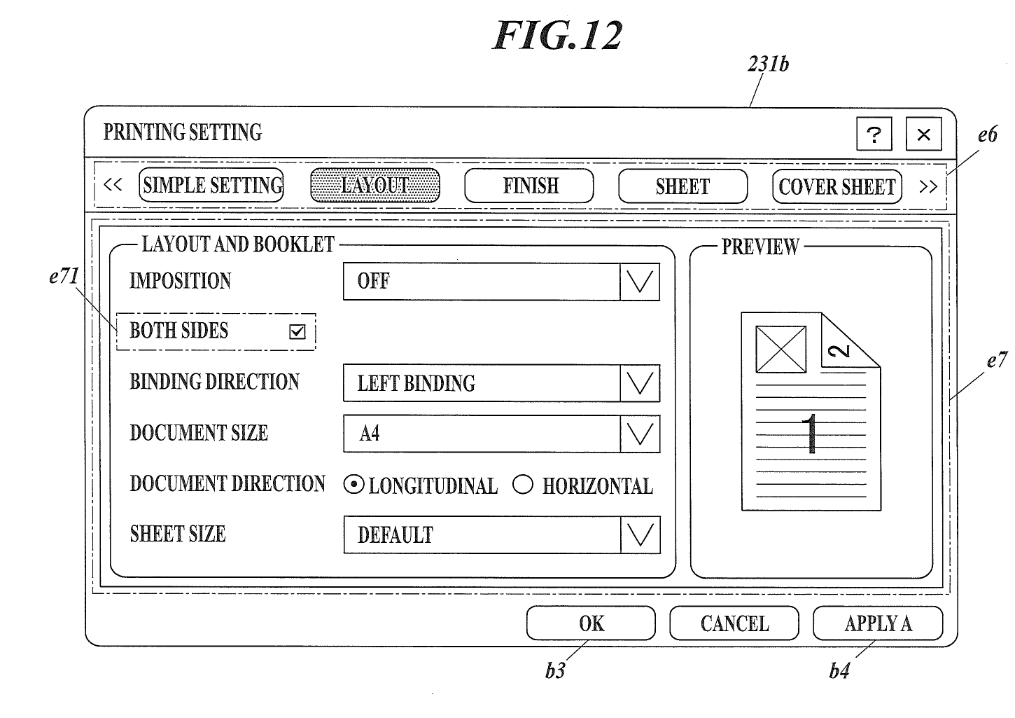

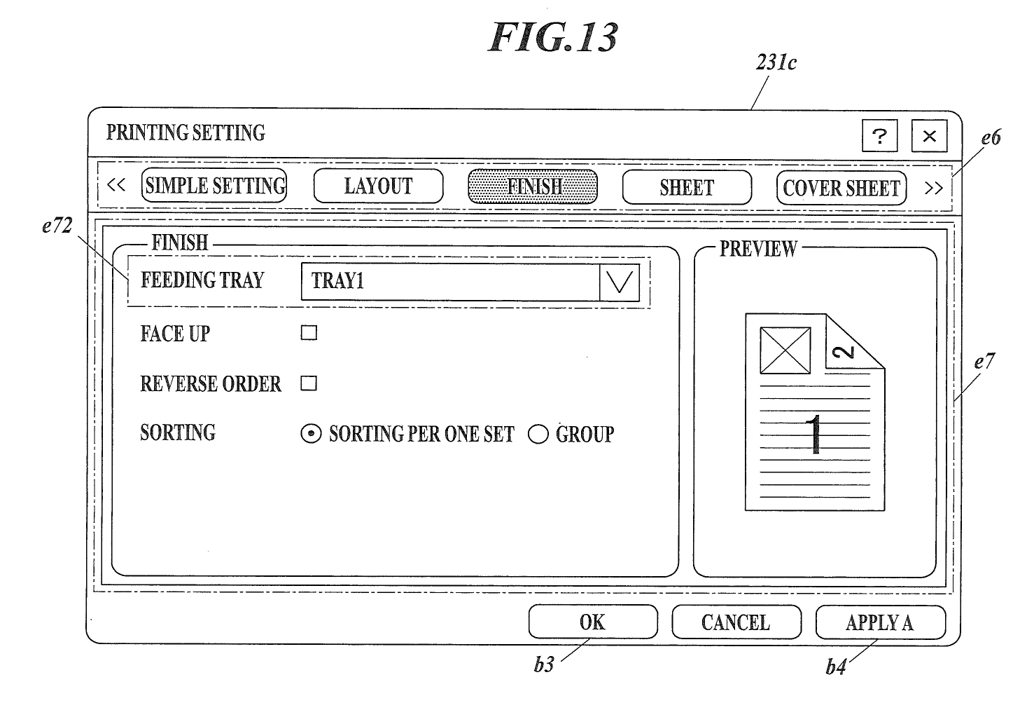

Specifically, the CPU 21 specifies the image data (image file or document file) and the like to be printed based on user's operation performed through the operation section 22, and allows the display section 23 to display the printer driver screen 231 (see FIGS. 12 and 13). The CPU 21 then sets the information such as the number of sets (number of copies), print range, and printing method (duplex printing/single-side printing) based on the input signal from the operation section 22 to create the print job information. After that, the CPU 21 creates the print job based on the print job information and the specified image data. This print job is transmitted to the image forming apparatus 10 through the communication section 24 by the CPU 21.

The CPU 21 generates the feeding section information setting data to be sent to the image forming apparatus 10 in cooperation with the printer driver program 261. The CPU 21 then transmits the feeding section information setting data to the image forming apparatus 10 through the communication section 24.

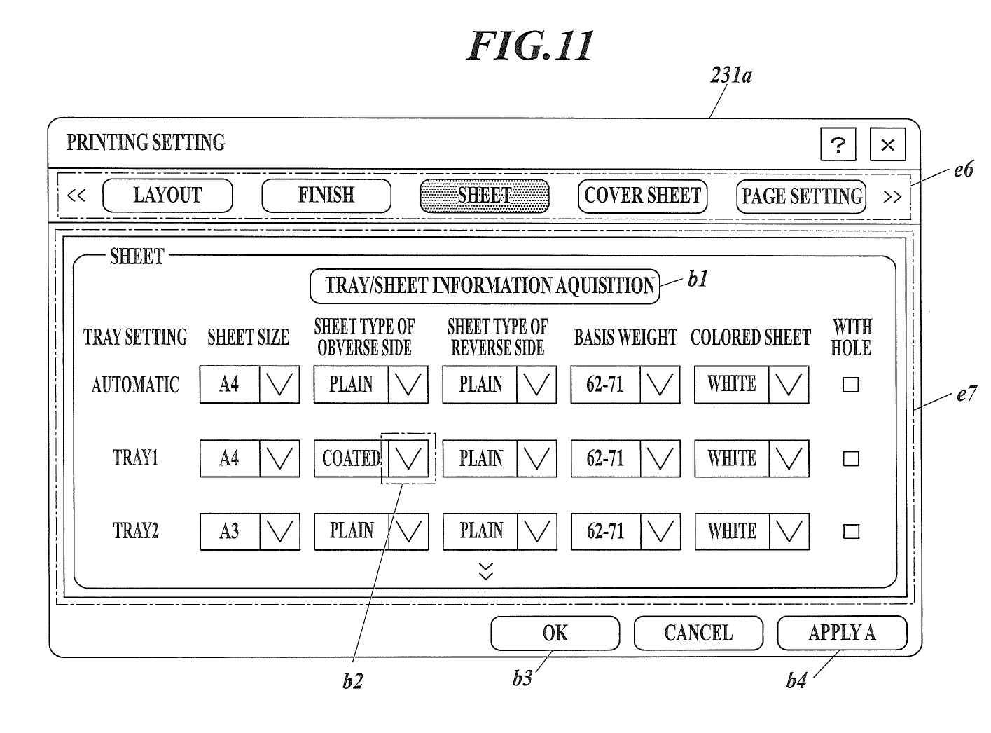

Specifically, the CPU 21 allows the display section 23 to display the printer driver screen 231 (see FIG. 11) based on user's operation performed through the operation section 22. Based on the input signal from the operation section 22, the CPU 21 creates the feeding section information setting data including sheet attribute information such as “sheet size”, “sheet type (obverse side)”, “sheet type (reverse side)”, “basis weight” and “colored sheet”. After that, the CPU 21 transmits this feeding section information setting data to the image forming apparatus 10 through the communication section 24.

Incidentally, the feeding section information setting data is created as data corresponding to each of the feeding sections. For example, it is created as the feeding section information setting data regarding the first feeding section 18a, the feeding section information setting data regarding the second feeding section 18b, the feeding section information setting data regarding the third feeding section 18c, and the feeding section information setting data regarding the fourth feeding section 18d.

### [Printer Driver Screen]

Next, FIGS. 11-13 show examples of the printer driver screen 231 to be displayed on the display section 23. FIG. 11 shows the printer driver screen 231a for setting the feeding section information, and FIGS. 12 and 13 show the printer driver screens 231b, 231c for setting the print job information.

As shown in FIGS. 11-13, each of the printer driver screens 231a-231c is composed of setting item selection region e6, information setting region e7, and so on.

The setting item selection region e6 is a region for selecting the item to be set in the printer driver screen 231. In the setting item selection region e6, the items such as “simple setting”, “layout”, “finish”, “sheet”, “cover sheet” and “page setting” are displayed. Any one of these items is selected based on user's operation.

The information setting region e7 is a region for setting information regarding the item selected in the setting item selection region e6.

The screen shown in FIG. 11 is displayed when the item “sheet” is selected. As shown in FIG. 11, in the information setting region e7, a tray/sheet information acquisition button b1, candidate value display button b2, and information for setting the feeding section information d2 are displayed. Specifically, in the information setting region e7, the sheet information such as “sheet size”, “sheet type (obverse side)”, “sheet type (reverse side)”, “basis weight”, “colored sheet” and “with hole” of each of the feeding sections (first-fourth feeding sections 18a-18d) is displayed. Incidentally, “with hole” corresponds to “punch hole”.

When the tray/sheet information acquisition button b1 is depressed by user's operation, the CPU 21 sends the feeding section information acquisition request to the image forming apparatus 10 through the communication section 24. The CPU 21 receives the feeding section information d2 from the image forming apparatus 10 to allow the RAM 25 to store the received information. Then, the CPU 21 allows the display section 23 to display the sheet information of each of the feeding sections (first-fourth feeding sections 18a-18d) based on the feeding section information d2. The CPU 21 allows the feeding section information d2 to be an initial value of the feeding section information setting data.

When the candidate value display button b2 of each of pieces of the sheet information is depressed by user's operation, the candidate values settable with respect to the corresponding sheet information are displayed. For example, when depressing the candidate value display button b2 of “sheet type (obverse side)” of tray 1, “coated”, “additional printing”, “high-quality”, “plain”, “for book”, “rough” and “non-printing insertion” are displayed. Based on user's operation, any one of the candidate values is selected. When any one of the candidate values is selected, the CPU 21 sets the selected value to the feeding section information setting data to update the value. Moreover, the CPU 21 updates the information displayed in the information setting region e7.

When an OK button b3 or an apply button b4 is depressed by user's operation, the CPU 21 transmits the feeding section information setting data to the image forming apparatus 10 through the communication section 24.

As described above, among pieces of the sheet information displayed in the information setting region e7, “sheet type (obverse side)” is the obverse side information indicating the attribute specific to the obverse side of the print sheet, and “sheet type (reverse side)” is the reverse side information indicating the attribute specific to the reverse side of the print sheet. In addition, “sheet size”, “basis weight”, “colored sheet” and “with hole” are the common information indicating the attribute of the print sheet itself.

Thus, on the printer driver screen 231a, a user does not need to input settings of the obverse side and the reverse side separately with respect to the attribute of the print sheet itself, namely the items “basis weight”, “colored sheet” and “with hole” regarding the common attribute between the obverse side and the reverse side. In other words, a user needs to input settings separately only with respect to the item “sheet information” (“sheet information (obverse side)” and “sheet information (reverse side)”) regarding the attribute specific to the obverse and reverse sides. Thus, user's work efficiency when image forming processing is performed on both sides of the print sheet whose obverse side and reverse side have different attributes from each other can be improved

The screen shown in FIG. 12 is displayed when the item “layout” is selected in the setting item selection region e6. As shown in FIG. 12, in the information setting region e7, the printing method setting region e71 which is a region for setting the value of “printing method” of the print job information d1 and the like is displayed.

By checking/unchecking the check box in the printing method setting region e71 based on user's operation, the CPU 21 performs setting of “printing method” of the print job information d1.

When an OK button b3 or the apply button b4 is depressed based on user's operation, the CPU 21 reflects “printing method” and other items in the print job information d1 to be transmitted to the image forming apparatus 10.

The screen shown in FIG. 13 is displayed when the item “finish” is selected in the setting item selection region e6. As shown in FIG. 13, in the information setting region e7, the feeding section selection region e72 which is a region for selecting the feeding section 18 (first-fourth feeding sections 18a-18d) and the like is displayed.

When any one of the first feeding section 18a (tray 1), the second feeding section 18b (tray 2), the third feeding section 18c (tray 3), the fourth feeding section 18d (tray 4), and automatic is selected on the feeding section selection region e72 based on user's operation, the CPU 21 reflects the value of the feeding section information d2 (first-fourth feeding section information d21-d24) of the selected feeding section 18 in the print job information d1 to be transmitted to the image forming apparatus 10. Incidentally, the CPU 21 sends the feeding section information acquisition request to the image forming apparatus 10 through the communication section 10 to obtain the feeding section information d2.

When not-shown print button is depressed by user's operation, the CPU 21 transmits the print job including the print job information d1 set in the printer driver screens 231b, 231c and the like to the image forming apparatus 10 through the communication section 24 to perform image forming processing. In other words, according to the example of FIG. 4, the print job to be transmitted to the image forming apparatus 10 includes the print job information containing information indicating the coated sheet as the attribute specific to the obverse side of the print sheet, and information indicating the plain sheet as the attribute specific to the reverse side of the sheet.

### [Specific Operation of Image Forming Apparatus]

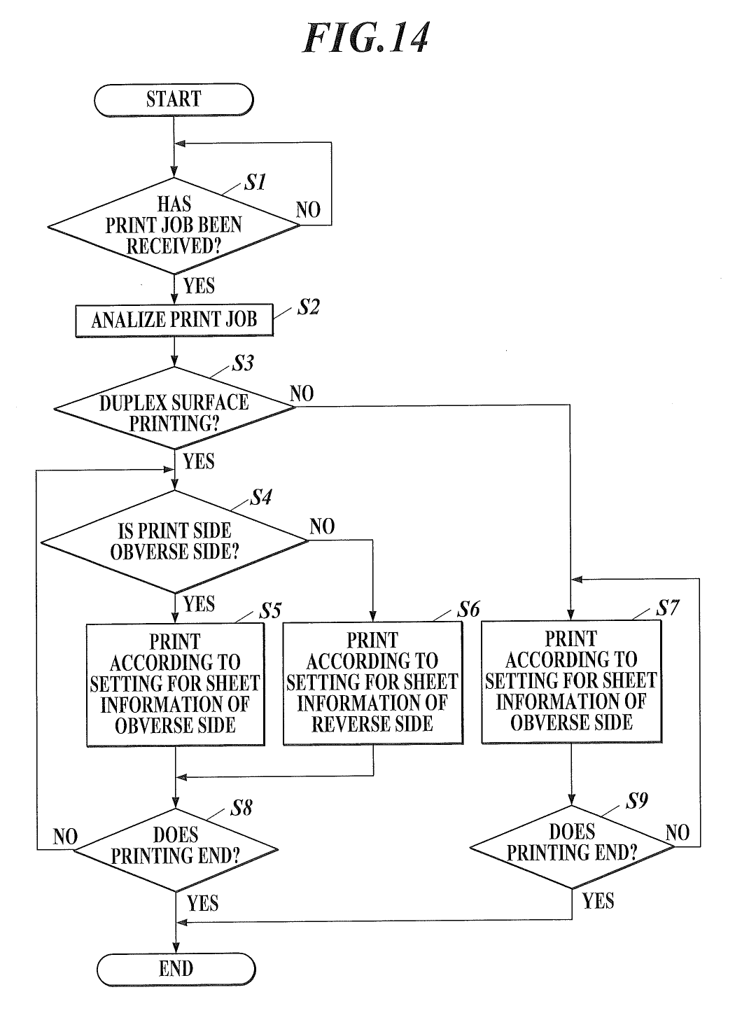

Next, specific operations of a series of processing regarding image formation performed by the CPU 111 will be described with reference to FIG. 14. FIG. 14 is a flowchart showing the series of processing regarding image formation. Incidentally, the flowchart is provided on the assumption that the print job is transmitted from the client terminal 20.

Firstly, when the CPU 111 receives the print job with the communication I/F section 114 from the client terminal 20 (Step S1; YES), the print job is analyzed (Step S2).

Specifically, the CPU 111 refers to the value of “printing method” of the print job information d1 included in the print job. When the value of “printing method” is “both sides”, the CPU 111 judges that image forming processing according to the print job is duplex printing (Step S3; YES). On the other hand, when the value of “printing method” is “single side”, the CPU 111 judges that image forming processing according to the print job is single-side printing (Step S3; NO).

In the case of duplex printing (Step S3; YES), the CPU 111 judges whether the printing side being processed is the obverse side or the reverse side (Step S4).

When the printing side is the obverse side (Step S4), the CPU 111 controls image forming processing based on the obverse side information and the common information which are included in the print job information d1, the print control condition information d3 (see FIG. 5) stored in the PAM 112, and so on (Step S5).

Specifically, when explaining by the example of FIG. 4, the CPU 111 sets “coated” which is the value of “sheet information (obverse side)” of the obverse side information among “sheet type (obverse side)” and “sheet type (reverse side)” as the value of “sheet type”. Then, the CPU 111 refers to the print control condition information (see FIG. 5) to output the instruction regarding the print control to each of the function sections based on each parameter value in the case that “sheet type” is “coated” and “basis weight” of the common information is “62-71 g/m²”. Each of the function sections executes processing regarding the print control according to the instruction sent from the CPU 111. The parameter values become as follows: “fixing temperature” is 150° C., “transfer current” is 10 μA, “separation DC voltage” is 500V, and “feeding assisting fan” is on.

On the other hand, when the printing side is the reverse side (Step S4; NO), the CPU 111 controls image forming processing based on the reverse side information and the common information which are included in the print job information d1, and the print control condition information d3 stored in the RAM 112, and so on (Step S6).

Specifically, when explaining by the example of FIG. 4, the CPU 111 sets “plain” which is the value of “sheet information (reverse side)” of the reverse side information among “sheet type (obverse side)” and “sheet type (reverse side)” as the value of “sheet type”. Then, the CPU 111 refers to the print control condition information (see FIG. 5) to output the instruction regarding the print control to each of the function sections based on each parameter in the case that “sheet type” is “plain” and “basis weight” of the common information is ““62-71 g/m²”. Each of the function sections executes processing regarding the print control (image formation control) according to the instruction transmitted from the CPU 111. The parameter values become as follows: “fixing temperature” is 160° C., “transfer current” is 20 μA, “separation DC voltage” is 500V, and “feeding assisting fan” is off.

When processing in Steps S5, S6 ends, the CPU 111 judges whether or not there is the image data of next page to be printed. In other words, the CPU 11 judges whether or not the printing has completed (Step S8).

When judging that the printing has completed (Step S8; YES), the CPU 111 ends the series of processing regarding image formation. On the other hand, when judging that the printing has not completed (Step S8; NO), the CPU 111 judges whether the printing side of next print sheet is the obverse side or the reverse side (Step S4). Then, the CPU 111 continues the series of processing regarding image formation.

Reverting to Step S3, in the case of one-side printing (Step S3; NO), the CPU 111 controls image forming processing based on the obverse side information and the common information which are included in the print job information d1, and the print control condition information d3 stored in the RAM 112, and so on (Step S7).

When processing in Step S7 ends, the CPU 111 judges whether or not there is the image data of next page to be printed. In other words, the CPU 11 judges whether or not the printing has completed (Step S9).

When judging that the printing has completed (Step S9; YES), the CPU 111 ends the series of processing regarding image formation. On the other hand, when judging that the printing has not completed (Step S9; NO), the CPU 111 controls image forming processing of next page based on the obverse side information and the common information which are included in the print job information d1, and the print control condition information d3 stored in the RAM 112, and so on (Step S7).

As described above, according to the embodiment, the image forming apparatus 10 stores the obverse side information (“sheet type (obverse side)”) indicating the attribute specific to the obverse side of the sheet, the reverse side information (“sheet type (reverse side)”) indicating the attribute specific to the reverse side of the sheet, and the common information (“sheet size”, “basis weight” and “punch hole”) indicating the attribute of the sheet itself, as the feeding section information d2, in the RAM 112 and the storage section 113.

When duplex printing is performed based on the print job, the image forming apparatus 10 reads corresponding image forming condition (“fixing temperature”, “transfer current” and the like) from the print control condition information d3 based on the obverse side information and the common information, and performs image forming processing on the obverse side of the sheet specified in the print job based on the read image forming condition. Then, the image forming apparatus 10 reads corresponding image forming condition from the print control condition information d3 based on the reverse side information and the common information, and performs image forming processing on the reverse side of the sheet specified in the print job based on the read image forming condition.

As a result, in the case that image forming processing is performed on both sides of the sheet where the obverse side and the reverse side have different attributes from each other, user's work efficiency can be improved.

Specifically, a user performs inputting for setting the feeding section information d2 on the feeding section information setting screen 151 or the printer driver screen 231a prior to image forming processing on both sides of the sheet whose obverse side and reverse side have different attributes from each other. When image forming processing is performed on both sides of the sheet whose obverse side and reverse side have different attributes from each other, a user performs inputting for setting the print job information d1 of duplex printing from the print job information inputting screen 152 or the printer driver screens 231b, 231c to allow the image forming apparatus 10 to perform image forming processing. As result, it becomes unnecessary for a user to reset the sheet for each of the sides or to input again the attribute (sheet information) of the sheet, and thereby work efficiency can be improved.

In addition, the description of the above embodiment is an example of the image forming apparatus according to the present invention, and the present invention is not limited to the embodiment. Also detailed configuration and detailed operation of each of the function sections which constitute the image forming apparatus may be properly changed.

Although the abovementioned embodiment discloses the example in which the ROM and HDD are used as computer-readable media storing the program, the present invention is not limited to the example. As other computer readable medium, nonvolatile memory such as a flash memory, a portable recording medium such as a CD-ROM may be adopted. In addition, also carrier wave may be adopted as a medium providing data of the program through communication lines.

What is claimed is:

1. An image forming apparatus to perform image forming processing based on a print job, which image forming apparatus comprising:
a storage section to store obverse side information indicating an attribute specific to an obverse side of a sheet and reverse side information indicating an attribute specific to a reverse side of the sheet; and
a control section to perform image forming processing on the obverse side of the sheet in an image forming condition according to the obverse side information stored in the storage section, and to perform image forming processing on the reverse side of the sheet in an image forming condition according to the reverse side information stored in the storage section, when image forming processing is performed on both sides of the sheet based on the print job.

2. The image forming apparatus of claim 1, wherein
the storage section further stores common information indicating an attribute of the sheet itself, which attribute is common between the obverse side and the reverse side of the sheet, and
the control section performs image forming processing on the obverse side of the sheet in an image forming condition according to the obverse side information and the common information which are stored in the storage section, and performs image forming processing on the reverse side of the sheet in an image forming condition according to the reverse side information and the common information which are stored in the storage section.

3. The image forming apparatus of claim 2 further comprising:
an operation section to receive the obverse side information, the reverse side information and the common information respectively, and wherein
the control section allows the storage section to store the obverse information, the reverse information and the common information which are received by the operation section.

4. The image forming apparatus of claim 3 wherein
each item regarding the obverse side information and the reverse side information which are received by the operation section includes at least one of items regarding a type of sheet processing and a sheet color, and
an item regarding the common information received by the operation section includes at least one of items regarding a basis weight of the sheet and presence/absence of a punch hole.

5. The image forming apparatus of claim 2 further comprising:
a feeding section to feed the stored sheet, and wherein
when image forming processing is performed on both sides of the sheet according to the print job, the control section specifies the sheet specified in the print job based on the obverse side information, the reverse side information, and the common information which are stored in the storage section, to supply the specified sheet to the feeding section.

6. A computer-readable recording medium storing a program which enables a computer performing image forming processing based on a print job to function as:
a storage section to store obverse side information indicating an attribute specific to an obverse side of a sheet and reverse side information indicating an attribute specific to a reverse side of the sheet; and
a control section to perform image forming processing on the obverse side of the sheet in an image forming condition according to the obverse side information stored in the storage section, and to perform image forming processing on the reverse side of the sheet in an image forming condition according to the reverse side information stored in the storage section, when image forming processing is performed on both sides of the sheet based on the print job.

7. The computer-readable recording medium of claim 6 wherein
the storage section further stores common information indicating an attribute of the sheet itself, which attribute is common between the obverse side and the reverse side of the sheet, and
the control section performs image forming processing on the obverse side of the sheet in an image forming condition according to the obverse side information and the common information which are stored in the storage section, and performs image forming processing on the reverse side of the sheet in an image forming condition according to the reverse side information and the common information which are stored in the storage section.

8. The computer-readable recording medium of claim 7 wherein
the program further enables the computer to function as:
an operation section to receive the obverse side information, the reverse side information, and the common information respectively, and wherein
the control section allows the storage section to store the obverse information, the reverse information, and the common information which are received by the operation section.

9. A print instruction apparatus to transmit a print job to an image forming apparatus to allow the image forming apparatus to perform image formation, which print instruction apparatus comprising:
a storage section to at least temporarily store obverse side information indicating an attribute specific to an obverse side of a sheet and reverse side information indicating an attribute specific to a reverse side of the sheet; and
a control section to generate the print job including the obverse side information and the reverse side information to transmit the generated print job to the image forming apparatus when a user instructs to perform image formation on both sides of the sheet.

10. The print instruction apparatus of claim 9, wherein
the storage section further stores common information indicating an attribute of the sheet itself, which attribute is common between the obverse side and the reverse side of the sheet, and
the control section generates, as the print job, a print job further including the common information.

11. A computer-readable recording medium storing a program which enables a computer transmitting a print job to an image forming apparatus and allowing the image forming apparatus to perform image formation to function as:
a storage section to at least temporarily store obverse side information indicating an attribute specific to an obverse side of a sheet and reverse side information indicating an attribute specific to a reverse side of the sheet; and
a control section to generate the print job including the obverse side information and the reverse side information to transmit the generated print job to the image forming apparatus when a user instructs to perform image formation on both sides of the sheet.

12. The computer-readable recording medium of claim 11, wherein
the storage section further stores common information indicating an attribute of the sheet itself, which attribute is common between the obverse side and the reverse side of the sheet, and
the control section generates, as the print job, a print job further including the common information.
